(19) United States
(12) Patent Application Publication
(10) Pub. No.: US 2016/0183714 A1
(43) Pub. Date: Jun. 30, 2016

(54) DUTCH COFFEE DRIP DEVICE

(71) Applicant: Kyungyeun HWANG, Daegu (KR)

(72) Inventor: Kyungyeun HWANG, Daegu (KR)

(21) Appl. No.: 14/892,827

(22) PCT Filed: Sep. 11, 2014
(86) PCT No.: PCT/KR2014/008477

§ 371 Date: Nov. 20, 2015

(30) Foreign Application Priority Data
Sep. 17, 2013 (KR) 10-2013-0111761

(51) Int. Cl. A47J 31/10; A47J 31/44

(52) U.S. Cl. CPC A47J 31/10; A47J 31/4403

(57) ABSTRACT

A Dutch coffee drip device includes a stand having an upper plate, a middle plate, and a lower plate; a water supply container being fixed to the upper plate; a pressure pump installed on the bottom of the water supply container to pressurize water supplied from the water supply container to spray the same; a dripper being fixed to the middle plate to contain coffee power, in which coffee is extracted by water sprayed from the pressure pump; and a drip server being fixed to the lower plate to store the coffee extracted from the dripper, wherein the pressure pump comprises: a driving motor, a cam performing a rotating operation by the driving motor; a pressure lever performing an up-and-down operation by the cam; and a spray nozzle spraying the water pressurized by the operation of the pressure lever.

### TECHNICAL FIELD

The present invention relates to a Dutch coffee drip device, and more particularly, to a Dutch coffee drip device used to extract coffee having a deep and mild taste and aroma by using water intermittently dropping at room temperature to extract the coffee from coffee power.

### BACKGROUND ART

One of coffees directly extracted from coffee powder made from coffee beans, a Dutch coffee is extracted from the coffee powder by allowing water to slowly and drop by drop fall in the coffee powder located thereunder. In general, such a Dutch coffee is extracted by using water at room temperature for a long duration of 3 to 24 hours.

Since the Dutch coffee extracted by a method described above uses the water at room temperature, the Dutch coffee is characterized by having relatively less content of caffeine, which is well extracted from hot water equal to or higher than 80° C., than that of a drip coffee, and having deep and mild flavor. Thus, a variety of Dutch coffee drip devices have been developed.

A Dutch coffee extracting device is disclosed in Korea patent publication No. 2013-81558 as an example thereof. As illustrated in FIG. 1, the Dutch coffee extracting device disclosed in the patent document comprises: a sealed water tank 100 having an opening 110; a first packing plug 200 assembled to the opening 110 to seal the water tank 100; a drip port 300 having one end inserted into the first packing plug 200 to be integrally assembled thereto; and a drip amount control valve 500 for fine control of the amount of water dripping down from the water tank 100 into a ground bean tank 400.

However, the Dutch coffee extracting device having the structure described above is configured to simply adjust the opening degree of the drip amount adjustment valve 500 located under the water tank 100 so that the speed of water falling into the ground bean tank 400 located thereunder may be adjusted, and therefore it is advantageous in that the amount (speed) of falling water may be easily adjusted. However, there is a limitation that since the water falls in droplet form, the water does not evenly fall across the coffee powder contained in the ground bean tank 400, so that the coffee is over-extracted from some portion of the coffee powder while the coffee is less-extracted from other portion of coffee powder with which the water is not in contact.

According to a drip coffee making apparatus disclosed in Japanese Patent Application Laid-Open No. 2005-137453, the position of a container containing coffee powder is moved to change the position of hot water falling from a water tank such that the water is evenly distributed across the coffee powder, and thereby the coffee is somewhat uniformly extracted. However, since the water basically falls in droplet form, this apparatus has also a limitation in extracting a uniform coffee. Further, the coffee making apparatus disclosed in this patent document pertains to a drip coffee making apparatus for extracting a drip coffee in which hot water is used.

Meanwhile, when a coffee as well as a Dutch coffee is extracted from most coffee extracting devices, a water supply hose is provided under a water tank to allow water to fall therethrough as in the coffee extracting devices exemplarily described above. A long-term use of such a hose may, however, invite a water scale inside the hose, which causes a poor hygiene as well as a clogging of the hose which does not allow a predetermined amount of water to be supplied to the coffee powder, so that a coffee having a uniform flavor may not always be extracted.

To solve the limitations that the coffee having the uniform flavor may not be extracted due to the water falling in droplet form, coffee extracting devices capable of extracting a uniform coffee from a coffee powder by spraying water from the above of the coffee powder are proposed in U.S. Pat. No. 6,483,154 and Japanese Patent Application Laid-Open No. 2005-539. However, since these coffee extracting devices are drip coffee extracting devices using hot water, it is difficult to apply the same to a Dutch coffee extracting device in which the water at room temperature is intermittently supplied into the coffee powder. Further, since a long hose is used to supply water, the limitation of the water scale being formed inside the hose in the long term use still remains.

### DISCLOSURE OF THE INVENTION

### Technical Problem

The present invention has been made to solve the problems of the existing coffee drip devices, and it is an object of the present invention to provide a Dutch coffee drip device which allows water at room temperature to be evenly supplied to a coffee powder, having an excellent hygiene, and capable of extracting a Dutch coffee having uniform flavor at all times.

### Technical Solution

The object of the present invention is achieved by providing a Dutch coffee drip device comprising: a stand having an upper plate, a middle plate, and a lower plate; a water supply container fixed to the upper plate; a pressurized pump installed in a lower part of the water supply container to pressurize water supplied from the water supply container to spray the same; a dripper fixed to the middle plate containing coffee powder therein, thereby a coffee is extracted by the water sprayed from the pressurized pump; and a drip server fixed to the lower plate and configured to put in the coffee extracted from the dripper, wherein the pressurized pump comprising: a driving motor; a cam performing a rotating operation by the driving motor; a pressure lever moving up and down by the cam; and a spray nozzle spraying pressurized water by an operation of the pressure lever.

It is preferred that the dripper comprises a dripper main body having an opening in an upper portion thereof and a lower end in which an extraction hole is defined, and a spray guide having a cylindrical shape to be assembled to the upper portion of the dripper main body, wherein a filter is installed inside the dripper main body.

It is preferred that a water inlet hole is defined in an upper portion of the pressure pump and is connected to a water supply hole defined in a lower end of the water supply container.

It is also preferred that a spray nozzle is installed to be fixed to the pressure lever so as to move up and down together with the pressure lever.

It is more preferred that one end of the pressure lever is elastically supported by a spring.

In addition, it is preferred that an LED is installed in a lower portion of the pressure pump.

### Advantageous Effects

According to present invention, since water is pressurized by a pressure pump to be sprayed through a spray nozzle for extraction of coffee, the water is evenly sprayed across coffee powder, and consequently an over-extraction or less-extraction of coffee from the coffee powder may be prevented from occurring.

Also, according to the present invention, since an operation of the pressure pump is performed by a mechanical cam, a predetermined operation may always be guaranteed, and consequently a Dutch coffee having uniform flavor and aroma may be extracted.

Further, according to the present invention, since a time interval at which water is sprayed over the coffee powder, may freely be increased by a control of a controller, a Dutch coffee having deeper flavor and aroma may be extracted.

### BRIEF DESCRIPTION OF THE DRAWINGS

FIG. 1 is a perspective view illustrating an existing Dutch coffee drip device.

FIG. 2 is a perspective view illustrating a Dutch coffee drip device according to the present invention.

FIG. 3 is an exploded perspective view illustrating a stand according to the present invention.

FIG. 4 is a perspective view illustrating a water supply container according to the present invention.

FIG. 5 is a perspective view illustrating a pressure pump according to the present invention.

FIG. 6 is a side view illustrating a pressure pump according to the present invention.

FIG. 7 is a perspective view illustrating a pressure pump installed according to the present invention.

FIG. 8 is a perspective view illustrating a dripper according to the present invention.

FIG. 9 is a schematic view illustrating a use example of a Dutch coffee drip device according to the present invention.

FIG. 10 is a schematic view illustrating a use example of a dripper according to another embodiment of the present invention.

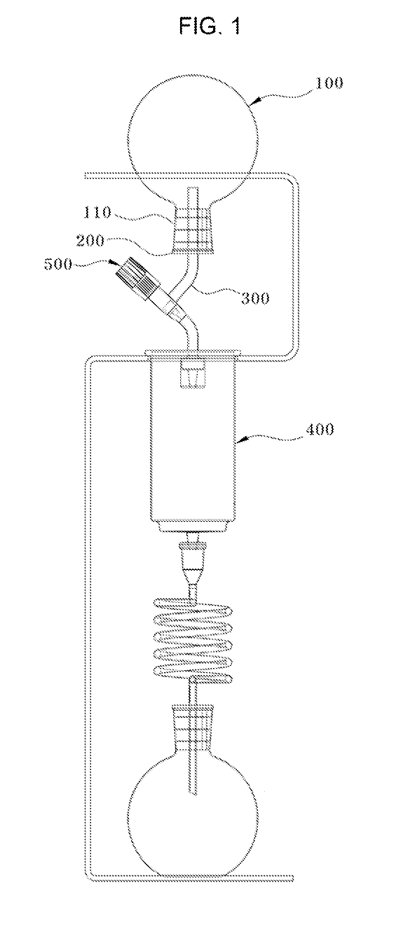

### EXPLANATIONS FOR REFERENCE NUMERALS

| | |
|---|---|
| 10: stand | 11: upper plate |
| 11A: through hole | 12: middle plate |
| 12A: through hole | 13: auxiliary plate |
| 13A: through hole | 14: lower plate |
| 15: supporting rod | 20: water supply container |
| 21: lid | 30: pressure pump |
| 31: bracket | 32: water inlet hole |
| 33: spray nozzle | 33A: fixing bracket |
| 34: pressure lever | 35: driving motor |
| 35A: cam | 36: supporting member |
| 37: LED | 40: dripper |
| 41: dripper main body | 41A: insertion unit |
| 42: spray guide | 42A: locking unit |
| 50: drip server | S: spring |

### MODE FOR CARRYING OUT THE INVENTION

Hereinafter, constituents and effect of the present invention will be described more in detail with reference to the accompanying drawings which illustrate preferred embodiments.

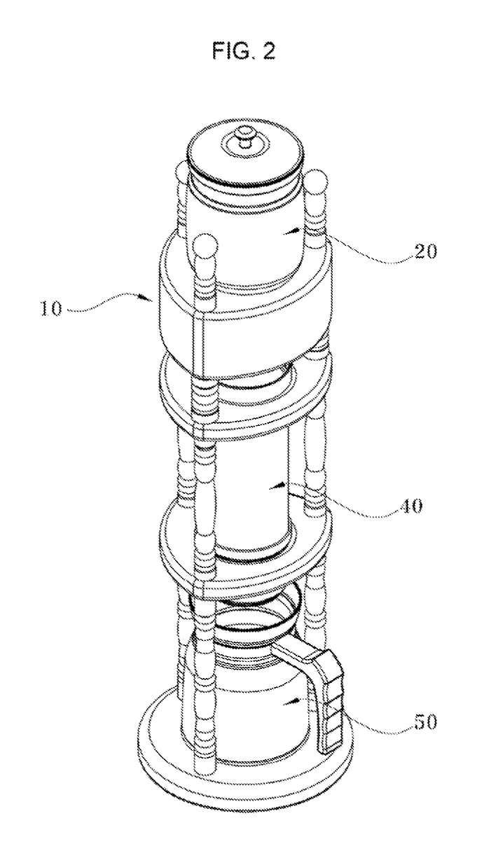

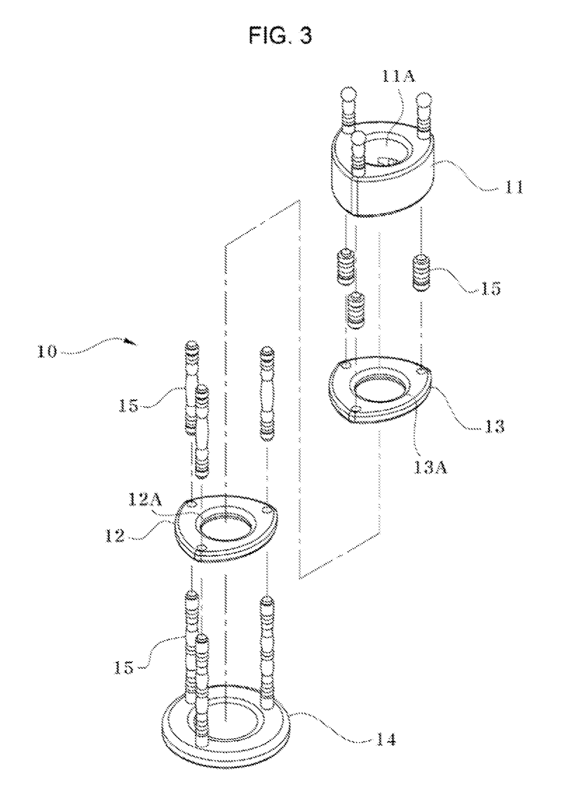

The present invention relates to a Dutch coffee drip device configured to extract a Dutch coffee using water at a room temperature. The Dutch coffee drip device according to the present invention includes a stand 10, a water supply container 20, a pressure pump 30, a dripper 40 and a drip server 50 as illustrated in FIGS. 2 and 3.

The stand 10 which serves as a frame of the Dutch coffee drip device according to the present invention includes a plurality of plates made in a double-layered structure of an upper layer and a lower layer as illustrated in FIG. 3, and a water supply container 20, a dripper 40, a drip server 50, and the like which will be described later are mounted on these layers, respectively.

In further detail, the stand 10 according to the present invention includes: an upper plate 11; a lower plate 14; and a middle plate installed between the upper and lower plates 11 and 14, and the upper, lower, and middle plates are installed in a state of being vertically spaced apart from each other by a plurality supporting rods 15.

Through holes 11A and 12A are respectively defined in centers of the upper plate 11 and the middle plate 12 which have a plate shape, and the water supply container 20 and the dripper 40 which will be later described are inserted in the through holes 11A and 12A to be fixed.

The pressure pump 30 which will be later described is installed in a lower portion of the through hole 11A defined in the upper plate 11 and is connected to a water supply hole (no reference numeral) defined in a lower end of the water supply container 20 that is installed in an upper portion of the through hole 11A.

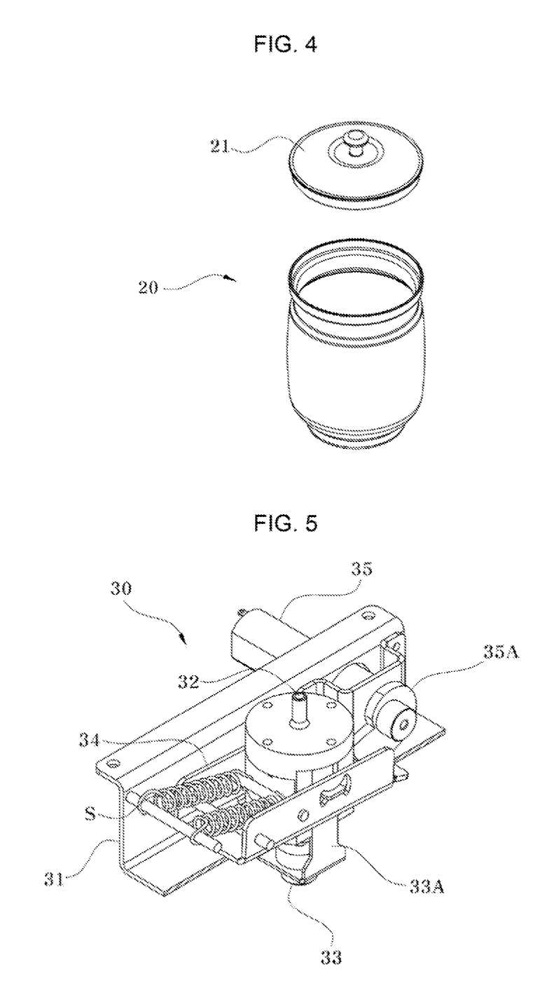

The water supply container 20 is located in the upper plate 11 of the stand 10. The water supply container 20 has an opened upper portion to receive water therein as illustrated in FIG. 4, and is also provided with a separate lid 21 to close the opening in the upper direction.

It is preferred that the water supply container 20 is made of a transparent glass or a transparent plastic material so that the amount of water contained therein may easily be viewed from the outside.

A water supply hole is protrusively defined in a lower end of the water supply container 20 in a lower direction so that the water contained in the water supply container 20 may be supplied to the pressure pump 30 which will be later described.

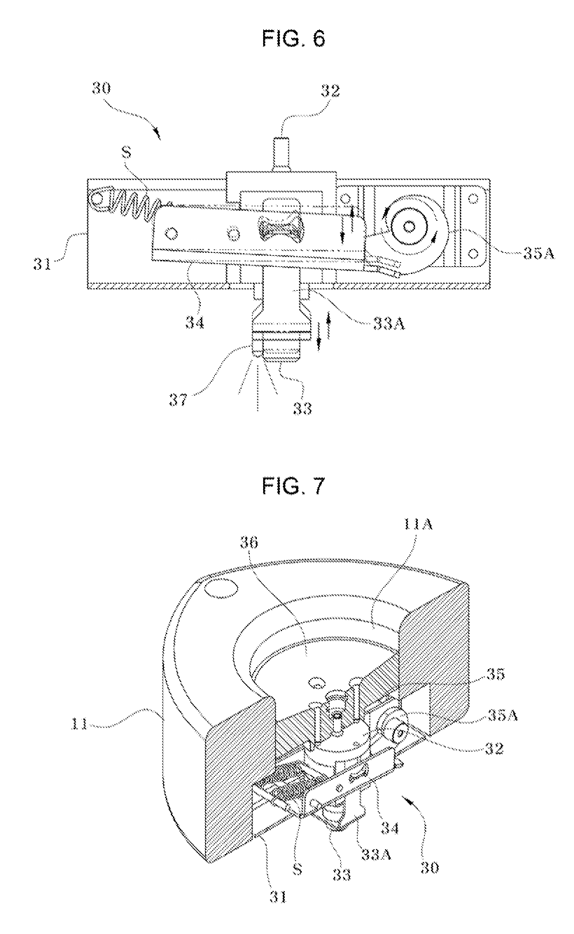

As illustrated in FIGS. 5 to 7, the pressure pump 30 installed in the lower portion of the water supply container 20 to pressurize and spray the water supplied through the water supply hole includes: a bracket 31 installed in and fixed to the through hole 11A of the upper plate 11; a water inlet hole 32 installed to the bracket 31 and connected to the water supply hole of the water supply container 20 so that water flows in; a spray nozzle 33 connected to the water inlet hole 32 to spray the water supplied from the water inlet hole in a lower direction; a pressure lever 34 configured to move the nozzle 33 up and down to pressurize the water; and a driving motor 35 configured to drive the pressure lever 34, in which a cam 35A is installed on a rotating shaft of the driving motor 35, the pressure lever 34 is installed such that one end thereof repeats contact and non-contact with the cam 35A according to the structure of the cam 35A, and a spring S elastically supports the other end of the pressure lever 34.

A spray nozzle 33 is fixedly installed in the pressure lever 34 as illustrated in FIG. 5, in which a fixing hole is respectively defined in both sides of the pressure lever 34, and a fixing bracket 33A surrounding the spray nozzle 33 is inserted in the fixing hole to be fixed.

Further, an LED 37 radiating light in various colors is installed around the spray nozzle 33 which is installed in the lower portion of the pressure pump 30, such that the LED 37 is turned on in various colors, when the water is sprayed from the spray nozzle, to illuminate the water being sprayed to produce a high sense of beauty.

According to the structure of pressure pump, as the driving motor 35 performs a rotating operation, the cam 35A performs a rotating operation, one end of the pressure lever 34 is thus pressed down to move in a lower direction by the rotating operation of the cam 35A, the pressure lever 34 is then released by the shape of the cam 35A and restored in an upper direction by an elastic force of the spring S so that the pressure lever 34 moves up and down, and the spray nozzle 33 fixed to the pressure lever 34 moves together with the pressure lever 34 by the pressure lever 34 moving up and down, so that the water in the water inlet hole 32 is pressurized to be sprayed in a lower direction through the spray nozzle 33.

The pressure lever 34 having a plate shape is formed by being bent: in a “ [symbol] ” shape having an opened upper portion and also has a through hole defined in a center thereof, and the water inlet hole 32 of the pressure pump 30 is located in the through hole.

One end of the pressure lever 34 is coupled to a hinge (no reference numeral) installed in the bracket 31 so that the other end thereof may tilt up and down, the cam 35A is installed to be in contact with the other end of the pressure lever 34, and thereby the pressure lever 34 moves up and down to pressurize and spray the water through the spray nozzle 33 installed thereunder.

A supporting member 36 may be further installed on an upper portion of the water inlet hole 32 as illustrated in FIG. 7, wherein an insertion hole (no reference numeral) in which the protruded water supply hole of the water supply container 20 is inserted is defined in the supporting member 36, and an O-ring is installed inside the insertion hole so that a watertight sealing with the water inlet hole is maintained.

The Dutch coffee has a deeper taste when water is supplied as slow as possible. Thus, in the Dutch coffee drip device, one drop of water is generally supplied every 3 to 4 seconds over the coffee powder.

Although the Dutch coffee has a deeper taste and flavor as water supply time increases, it is limited to further increase the water supply time in existing Dutch coffee extracting devices since the existing Dutch coffee extracting devices employ a natural drop of water.

Thus, the present invention provides a controller (not illustrated) disposed on an outer surface of the upper plate 11 of the stand 10, in which the controller includes an extraction time selection button by which the rotating speed of the motor is controlled in multiple steps, and consequently a user may select a longer extraction time by own preference to extract a coffee having a far deeper taste to enjoy.

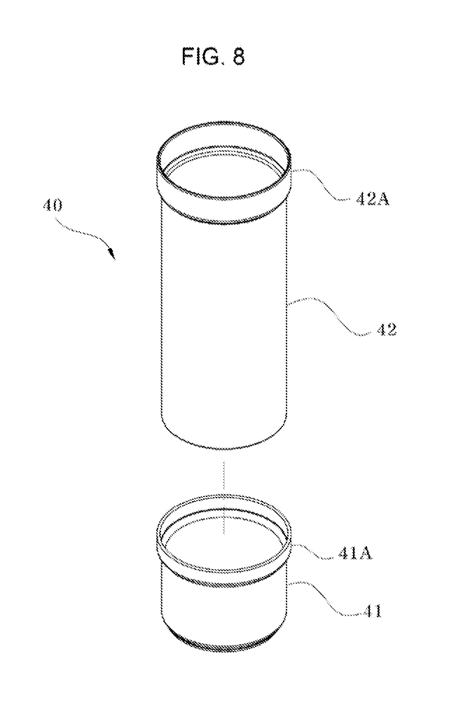

A dripper 40 which is a container having an opened upper portion and in which a coffee powder is put and received is installed over the middle plate 12 of the stand 10 such that a coffee may be extracted by the water sprayed from the pressure pump 30 located thereabove. For this purpose, the dripper 40 is provided in a cylindrical shape having an extraction hole defined in a lower portion thereof and has a filter (no reference numeral) insertedly installed inside thereof as illustrated in FIG. 8.

A locking unit having a relatively larger outer diameter when compared with that of the through hole 12A is formed in an upper portion of the dripper 40 so that the dripper 40 may be fixedly coupled after being inserted in the through hole 12A.

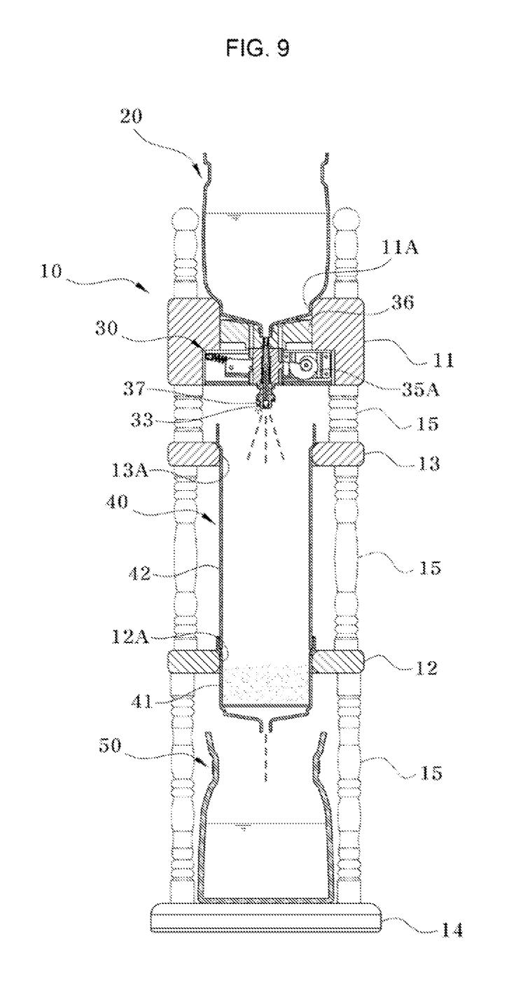

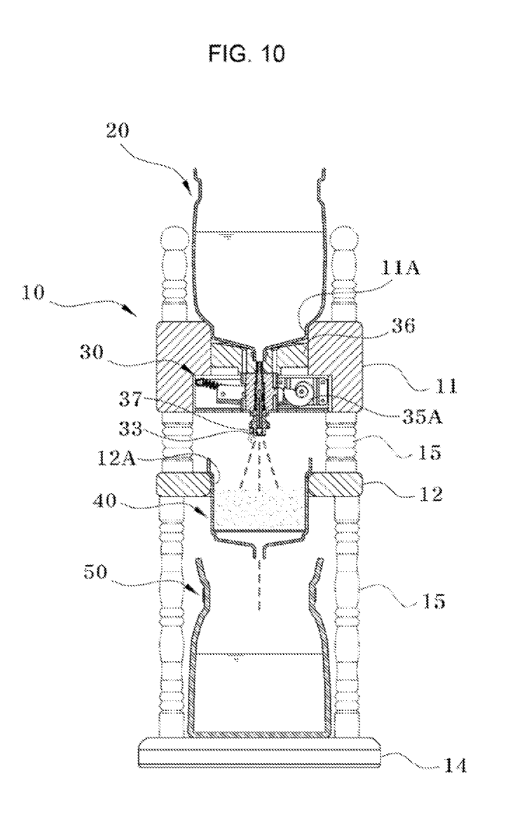

Meanwhile, the dripper 40 according to the present invention may include a dripper main body 41 having an extraction hole defined in a lower end thereof, and a spray guide 42 in a cylindrical shape having an opened upper surface and a opened lower surface to be assembled to the upper portion of the dripper main body 41 as illustrated in FIG. 9. The spray guide 42 prevents water sprayed through the spray nozzle 33 of the pressure pump 30 from absorbing dust or the like in the air due to the water being in contact with the outside air, and simultaneously from scattering to the outside.

The spray guide 42 is inserted in the dripper main body 41 to be assembled. An insertion unit 41A having an internal diameter defined to be the same as the outer diameter of the lower end of the spray guide 42 is provided on an upper portion of the dripper main body 41 for the assembly. The insertion unit 41A serves as a locking unit as described above.

When the dripper 40 includes the spray guide 42 and the dripper main body 41, an auxiliary plate 13 is installed between the upper plate 11 and the middle plate 12 such that the spray guide 42 and the dripper main body 41 are respectively fixed, a through hole 13A having the same size as the through hole 12A defined in the upper plate is defined at the same location in a center of the auxiliary plate 13, the spray guide 42 is inserted in the through hole 13A to be fixed, and a locking unit 42A having an outer diameter that is larger than the diameter of the through hole 13A is formed in an upper portion of the spray guide 42 such that the spray guide 42 may be locked in the through hole 13A.

A filter is insertedly installed inside the dripper main body 41, and coffee powder is accommodated in the dripper main body 41, whereby the coffee is extracted through a process in which the water sprayed through the spray nozzle 33 is guided by the spray guide 42 to penetrate the dripper main body 41, and the extracted coffee falls into a drip server 50 to be stored therein through the extraction hole (no reference numeral) defined in the lower end of the dripper main body 41.

The drip server 50 installed at the lower plate 14 of the stand 10 is a container for storing the extracted coffee therein as illustrated in FIGS. 2 and 9. The drip server 50 is made of a transparent material so that the amount of the extracted coffee may easily be viewed, and a handle (no reference numeral) may be provided on a left surface thereof so that a user may easily lift up the drip server 50.

When using the Dutch coffee drip device structured according to the present invention as described above, a filter is installed inside the dripper 40, the dripper 40 is then fixedly installed in the middle plate 12 of the stand 10 after a predetermined amount of coffee powder is put therein, water is then supplied to the water supply container 20, a user then operates a controller to select the falling speed (time) of the water and presses a start button, then the driving motor 35 performs a rotating operation, and thereby the cam 35A performs a rotating operation as illustrated in FIG. 9.

When the cam 35A performs the rotating operation, one end of the pressure lever 34 installed to be in contact with the cam 35A is repeatedly pressed and unpressed to pressurize the water, so that the water is sprayed toward the dripper 40 through the spray nozzle 33 attached to the pressure lever 34.

The water sprayed to the upper portion of the dripper 40 penetrates the coffee powder contained in the dripper 40, so that the coffee is extracted, and then the extracted coffee falls to be stored in the drip server 50 located thereunder through the extraction hole defined in the lower portion of the dripper 40.

As described above, according to the present invention, since water is pressurized by a pressure pump and sprayed over coffee powder through a spray nozzle, the water is evenly distributed over the coffee powder, so that a Dutch coffee having uniform taste and aroma may be extracted, and since a hose for supplying the water to the coffee powder is not required, the coffee being hygienically more safe may be extracted.

1. A Dutch coffee drip device for extracting coffee using water at room temperature, the Dutch coffee drip device comprising:
a stand provided with an upper plate, a middle plate, and a lower plate;
a water supply container fixed to the upper plate;
a pressure pump installed at an upper portion of the water supply container to pressurize water supplied from the water supply container so as to spray the same;
a dripper fixed to the middle plate to receive coffee power therein, thereby a coffee is extracted by water sprayed from the pressure pump; and
a drip server fixed to the lower plate to store the coffee extracted from the dripper, wherein
the pressure pump comprising: a driving motor; a cam configured to perform a rotating operation by the cam; and a spray nozzle configure to spray water pressurized by the operation of the pressure lever.

2. The Dutch coffee drip device of claim 1, wherein the dripper comprises: a dripper main body having an opening on an upper portion thereof and an extraction hole defined on a lower end thereof; and a spray guide having a cylindrical shape to be assembled to the upper portion of the dripper main body, wherein a filter is installed inside the dripper main body.

3. The Dutch coffee drip device of claim 1, wherein a water inlet hole is defined at an upper portion of the pressure pump, and the water inlet hole is connected to a water supply hole defined at a lower end of the water supply container.

4. The Dutch coffee drip device of claim 1, wherein the spray nozzle is fixedly installed in the pressure lever to move up and down together with the pressure lever.

5. The Dutch coffee drip device of claim 4, wherein one end of the pressure lever is elastically supported by a spring S.

6. The Dutch coffee drip device of claim 1, wherein an LED is installed at a lower portion of the pressure pump.

7. The Dutch coffee drip device of claim 2, wherein an LED is installed at a lower portion of the pressure pump.
